(19) United States
(12) Patent Application Publication
(10) Pub. No.: US 2025/0173581 A1
(43) Pub. Date: May 29, 2025

(54) Computer-implemented Method for Training a Multi-task Neural Network

(71) Applicants: Continental Autonomous Mobility Germany GmbH, Ingolstadt (DE); NANYANG TECHNOLOGICAL UNIVERSITY, Singapore (SG)

(72) Inventors: Haosen Shi, Singapore (SG); Shen Ren, Singapore (SG); Tianwei Zhang, Singapore (SG)

(73) Assignees: Continental Autonomous Mobility Germany GmbH, Ingolstadt (DE); NANYANG TECHNOLOGICAL UNIVERSITY, Singapore (SG)

(21) Appl. No.: 18/953,451

(22) Filed: Nov. 20, 2024

(30) Foreign Application Priority Data
Nov. 24, 2023 (GB) GB2317986.4

(51) Int. Cl. G06N 3/0985; G06N 3/045

(52) U.S. Cl. CPC G06N 3/0985; G06N 3/045

(57) ABSTRACT

A computer-implemented method for training a multi-task neural network for predicting a plurality of T tasks, T≥2, simultaneously based on input data, the method comprising: a) providing a multi-task neural network, a training dataset [symbol] for training the neural network on the plurality of T tasks, and a validation dataset [symbol] ′ for validating the neural network on the plurality of T tasks; and b) training the multi-task neural network for the plurality of T tasks across a predefined number N_{epoch} of training epochs by using the training dataset [symbol] and the validation dataset [symbol] ′ such that a combined loss function is minimized within the predefined number N_{epoch} of training epochs.

### CROSS-REFERENCE TO RELATED APPLICATIONS

This application claims priority to and benefit of United Kingdom Application No.: GB2317986.4, filed on Nov. 24, 2023 and titled “Computer-implemented method for training a multi-task neural network.” The contents of the above-identified application are relied upon and incorporated herein by reference in their entirety.

### TECHNICAL FIELD

The invention relates to a computer-implemented method for training a multi-task neural network. The invention further relates to a computing and/or controlling device, a computer program, and a computer-readable storage medium.

### BACKGROUND

A deep neural network model which has a suitable architecture and is trained by multitask learning algorithms can perform multiple tasks at the same time. Most recent works have investigated these two components from different perspectives and designed many deep neural network architectures and multitask training algorithms in a lot of domains.

However, in general, multitask neural networks are difficult to train. The core difficulty of the multi-task learning problem is that different tasks require capturing different levels of information and then to exploit them to varying degrees.

However, due to the black box nature of deep neural networks, it may be hard to know what features or information the model must extract from the input data for each task and how the model learns such feature extraction process.

### SUMMARY OF THE INVENTION

The object of the invention is to provide an improved method for training a multi-task neural network.

The object of the invention is achieved by the subject-matter of the independent claims. Advantageous embodiments of the invention are subject-matter of the dependent claims.

In one aspect, the invention provides a computer-implemented method for training a multi-task neural network for predicting a plurality of T tasks, T≥2, simultaneously based on input data, the method comprising:
a) providing a multi-task neural network, a training dataset [symbol] for training the neural network on the plurality of T tasks, and a validation dataset [symbol] ′ for validating the neural network on the plurality of T tasks; and
b) training the multi-task neural network for the plurality of T tasks across a predefined number N_{epoch} of training epochs by using the training dataset D and the validation dataset [symbol] ′ such that a combined loss function is minimized within the predefined number N_{epoch} of training epochs, wherein the combined loss function for a respective training epoch depends on:
a sum of a plurality of single-task loss values for the respective training epoch and respectively from a single-task loss function Lₜ for a corresponding task t=1, . . . , T, and
a regularization value for the respective training epoch and from a regularization function for all pairs of tasks t₁, t₂=1, . . . , T, the regularization function for a respective pair of tasks t₁, t₂=1, . . . , T being based on a difference between a corresponding pair of distance metric values respectively from a distance metric function d, each respective distance metric value for the corresponding task t=1, . . . , T being calculated in the respective training epoch by evaluating the distance metric function d on a corresponding single-task control parameter θₜ′ predicted in said training epoch, the corresponding single-task control parameter θₜ′ being predicted in said training epoch by an optimization neural network Optim_{ϕ} that is meta-trained in said training epoch in relation to said task.

An advantage of the method may be that it can be used for training any neural network, e.g., a multilayer perceptron, a convolutional neural network, a deep neural network, for predicting a plurality of T tasks, T≥2, simultaneously.

The training dataset and the validation dataset used to meta-train the neural network may be both split from an original dataset. Thus, in the precent case, the term “validation dataset” may be different from the widely-used term in deep learning which is only used for evaluating the performance or finding the hyperparameters.

A further advantage of the method may be that it can align or balance the training speed of the plurality of T tasks having different levels of a learning complexity. Furthermore, the method may improve training of the multi-task neural network such that an averaged prediction accuracy across several or all T tasks and/or selected prediction accuracies for predicting one or more selected tasks are maximized. Additionally, or alternatively, the method may further improve training of the multi-task neural network such that selected prediction accuracies for predicting one or more selected tasks are similar in scale.

A further advantage of the method may be that it can decrease the size of the trained multi-task neural network.

Preferably, the respective single-task loss function Lₜ for the corresponding task t=1, . . . , T is validated in the respective training epoch on the corresponding single-task control parameter θₜ′ predicted in said training epoch and on inputs of the validation dataset [symbol] ′ related to said task.

Preferably, c1) the optimization neural network Optim_{ϕ} includes the multi-task neural network that is trained across the predefined number N_{epoch} of training epochs such that the combined loss function is minimized within the predefined number N_{epoch} of training epochs.

An advantage of the method may be that the optimization neural network Optim_{ϕ} can be used for both, as the multi-task neural network itself and as the neural network for predicting the corresponding single-task control parameter θₜ′. This may reduce the computation resources needed for training.

Preferably, c2) the optimization neural network Optim_{ϕ} is parameterized with an optimization parameter θₜ′ that is adapted in the respective training epoch based on the optimization parameter θₜ′ of the corresponding previous training epoch and a gradient descent of the combined loss function.

Parameterization of the optimization neural network Optim_{ϕ} similarly may have the advantage that the optimization neural network Optim_{ϕ} can be used for both, as the multi-task neural network itself and as the neural network for predicting the corresponding single-task control parameter θₜ′.

Preferably, the optimization neural network Optim_{ϕ} is meta-trained in the respective training epoch for predicting the corresponding single-task control parameter θₜ′ in said training epoch based on inputs of the training dataset [symbol] related to said task t=1, . . . , T inputted to the optimization neural network Optim_{ϕ}.

The training dataset [symbol] and the validation dataset [symbol] ′ may represent joint datasets, that are combined according to the different tasks to be learned. For example, the training dataset [symbol] and the validation dataset [symbol] ′ may be joint datasets with multiple labels y₀, . . . ,y_{T} for learning an object detection task, a semantic segmentation task, and/or a depth estimation task. Thus, the training dataset [symbol] and the validation dataset D′ may be adapted according to the needs and use case.

Preferably, the optimization neural network Optim_{ϕ} is trained for generating a multiple-task control parameter θᵢ for the respective training epoch based on the multiple-task control parameter θᵢ₋₁ for the corresponding previous training epoch and/or inputs of the training dataset [symbol] related to each of the plurality of T tasks inputted to the optimization neural network Optim_{ϕ}.

The multiple-task control parameter θᵢ may be used as a common measure over all T tasks based on which the corresponding single-task control parameter θₜ′ is predicted. The multiple-task control parameter θᵢ may further be used as a common measure over all T tasks based on which the distance metric function d is evaluated. Thus, the role of multiple-task control parameter θᵢ may be multi-functional which may reduce the computation resources needed for training. This may provide an improved method for simultaneous learning of the different tasks.

Preferably, the optimization neural network Optim_{ϕ} is meta-trained in the respective training epoch for predicting the corresponding single-task control parameter θₜ′ in said training epoch based on the multiple-task control parameter θᵢ₋₁ of the corresponding previous training epoch inputted to the optimization neural network Optim_{ϕ}.

Preferably, the respective distance metric value for the respective training epoch is calculated in said training epoch by evaluating the distance metric function d on the multiple-task control parameter θᵢ for said training epoch.

Preferably, the optimization neural network Optim_{ϕ} is meta-trained for one or more meta-training steps in the respective training epoch and/or the optimization neural network Optim_{ϕ} is meta-trained in said training epoch for predicting the single-task control parameter θₜ′ for the final training epoch.

An advantage of the method may be that is the optimization neural Optim_{ϕ} is trained for predicting the single-task control parameter θₜ′ for the final training epoch. Thus, in each training epoch, the training of the different tasks is aligned in a perspective manner with respect to the final training epoch. This may improve the training of the multi-task neural network.

Preferably, the combined loss function and/or the single-task loss functions Lₜ are based on one, several, or all of the following: a focal loss, a cross-entropy loss, and a bounding box regression loss.

Preferably, the distance metric function is based on one, several, or all of the following: a Kullback-Leibler (KL) divergence metric, a CKA distance metric, and an L2 distance metric.

Preferably, the regularization function is based on a norm function of the difference, the norm function being preferably an absolute value function.

Preferably, the method further comprises:
d1) Storing the trained multi-task neural network for predicting the plurality of T tasks simultaneously in a controlling device for generating a control signal for controlling an apparatus;
d2) Inputting input data related to the apparatus to the trained multi-task neural network; and
d3) Generating, by the controlling device, the control signal for controlling the apparatus based on an output of the trained multi-task neural network.

The controlling device may be implemented any kind of apparatus, e.g., in an autonomous vehicle. The input data may thus relate to sensor data of said apparatus of autonomous vehicle. In an autonomous vehicle, the controlling device may generate control signals for navigating the vehicle. According to the method, the multi-task neural network may thus be trained for predicting one or more navigation tasks.

In another aspect, the invention provides a computing and/or controlling device comprising means adapted to execute the steps of the method according to any of the preceding embodiments.

In another aspect, the invention provides a computer program comprising instructions to cause a computing and/or controlling device to execute the steps of the method according to any of the preceding embodiments.

In another aspect, the invention provides a computer-readable storage medium having stored thereon the computer program.

Embodiments of the invention preferably have the following advantages and effects:
Preferred embodiments of the invention feature a novel method for understanding the stages of training for various tasks in multi-task learning, as well as a technique to align these stages for optimal joint performance.

The proposed methods may be individually packaged as a software module to be added to existing deep learning or deep multi-task training pipelines for model understandings and for enhanced joint performance. The technologies involved in preferred embodiments of the invention may also be widely applied to deep learning applications in the wild with distinctive training data distributions, such as multi-class, multi-modal, multi-label, and multi-domain learning.

The primary application of preferred embodiments of the invention is for deep multi-task model understandings and training dynamics optimization for perception tasks. Specifically, the technical problem that preferred embodiments of the invention is focused to solve is two-folds:
1. First, preferred embodiments of the invention can be used to understand the training progress of both, single-task and multi-task models, providing detailed insights into each layer of the neural network model. Preferred embodiments of the invention can be further applied to understand the challenging tasks/classes/data samples that are usually lower performed than other tasks. These understandings can be integrated with active learning or data resampling to improve the lower-performed tasks/classes in practical deep learning pipeline.
2. Second, preferred embodiments of the invention can be applied to align training stages during multi-task training using meta-learning to encourage that all tasks are jointly optimized to its best performance. Again, the method may also be directly applied to multi-class classification or object detection that is widely seen in automated and autonomous driving applications. This is particularly useful when there are challenging tasks/scenes involved in the applied scenarios that can are difficult to optimize to its best performance using traditional deep learning training methods.

The key technical innovations that set preferred embodiments of the invention apart from and offer advantages over prior art include:
1. A method to understand the single-task or multi-task neural network training progress, with detailed insights into each layer of the neural network model.
2. A method or system for training a multi-task neural network model effectively using meta-learning to learn a regularization loss, combined with the original multi-task loss function, to align the training progress of all tasks learned simultaneously for better joint performance. The multi-task neural network is preferably characterized as a single neural network, where the outputs consist of multiple task prediction results. It is trained using a combined loss function for each task.

To achieve above idea, preferred embodiments of the invention provide a metric to define and measure the training stage of each task and a meta-learning based optimization algorithm to implement a training process which keep aligned training stages for all tasks.

### BRIEF DESCRIPTION OF THE DRAWINGS

Embodiments of the invention are now explained in more detail with reference to the accompanying drawings of which

FIG. 1 shows a comparison of different schemes for training a neural network;

FIG. 2 shows an embodiment of a first computer-implemented method;

FIG. 3A and FIG. 3B show diagrams of results of the method according to FIG. 2;

FIG. 4 shows a first embodiment of a computer-implemented method for training a multi-task neural network; and

FIG. 5 shows a second embodiment of the computer-implemented method for training the multi-task neural network.

### DETAILED DESCRIPTION OF THE DRAWINGS

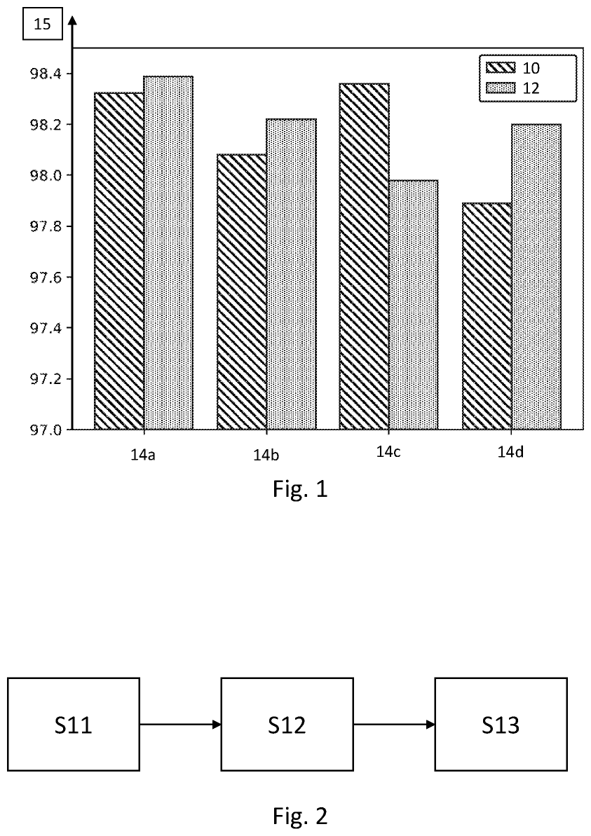

FIG. 1 shows a comparison of different schemes for training a neural network for predicting a first task 10 and/or a second task 12 in a first case 14a, a second case 14b, a third case 14c, and a fourth case 14d.

The first case 14a from the left indicates prediction accuracies 15 of a single-task neural network for predicting the first task 10 or the second task 12, respectively.

The neural network is trained for either the first task 10 or the second task 12, respectively.

The second case 14b indicates the prediction accuracies of a multi-task neural network for predicting the first task 10 and the second task 12 simultaneously. The multi-task neural network is trained simultaneously for both, the first task 10 and the second task 12, according to known methods.

The third case 14c indicates prediction accuracies of the multi-task neural network for predicting the first task 10 and the second task 12 simultaneously. In contrast to the second case 14c, the multi-task neural network is trained successively for both tasks 10, 12, starting with the first task 10.

The fourth case 14d indicates prediction accuracies of the multi-task neural for predicting the first task 10 and the second task 12 simultaneously. In contrast to the third case 14c, the multi-task neural network is trained starting with the second task 12.

As can be derived from FIG. 1, the different schemes yield different prediction accuracies for predicting the first task 10 and the second task 12, respectively. Additionally, the different schemes yield a different averaged prediction accuracy for both tasks 10, 12.

An idea of preferred embodiments of the invention is to provide an optimized scheme for training a multi-task neural network such that the prediction accuracies for predicting the first task 10 or the second task 12, respectively, are preferably similar in scale. Furthermore, the averaged prediction accuracy for both tasks 10, 12 should be maximized. To achieve this object, a further idea of preferred embodiments of the invention is to align a training speed of different tasks in a multi-task neural network.

FIG. 2 shows an embodiment of a first computer-implemented method. An example of a pseudo-code A of the method according to FIG. 2 may read as follows:

```
Require: training dataset [symbol]  , parameter θ₀, number of total
layers N_{layer}
  for i = 1,2, . . . , N_{epoch} do
    for x, y~ [symbol]   do
      θᵢ ← θᵢ₋₁ + α∇_{θ}L(M_{θ}(x), y)
    end for
  for i = 1,2, . . . , N_{epoch} do
    for j = 1,2, . . . , N_{layer} do
      M_{front} = M_{θ}_{ᵢ}[: j]
      ${M}_{b a c k} = {M}_{{θ}_{{N}_{e p o c h}}} [ j + 1 : ]$
      Record L(M_{back} ∘ M_{front}(x),y)
    end for
  end for
```

In a step S11, a single-task neural network M_{θ} for predicting a single task and a training dataset [symbol] for training the neural network M_{θ} on the task are provided. The single-task neural network M_{θ} is parameterized with a model parameter θ that is initialized with θ₀. The neural network M_{θ} further includes a plurality of N_{layer} network layers.

In a step S12, the neural network M_{θ} is trained by using the training dataset [symbol] such that a loss function L is minimized within a predefined number N_{epoch} of training epochs. In a respective training epoch i=1, . . . , N_{epoch}, the model parameter θᵢ is adapted or updated based on the model parameter θᵢ₋₁ of the previous corresponding training epoch and a gradient descent of the loss function L. In this way, for each training epoch i=1, . . . , N_{epoch}, the neural network M_{θ}_{ᵢ}, is calculated. Additionally, the model parameter θ_{N}_{_{epoch}} for the final training epoch may be predicted.

In a step S13, for each training epoch i=1, . . . ,N_{epoch} and for each network layer j=1, . . . ,N_{layer}, the loss function L of a joint neural network is recorded.

The joint neural network is merged by a front model M_{front} and a back model M_{back}. Therefore, the neural network M_{θ}_{ᵢ} for the respective training epoch i=1, . . . , N_{epoch} is clipped at a clipping layer of the neural network M_{θ}_{ᵢ} at a clipping position N_{clipping}=[1, . . . , N_{layer} −1].

The front model M_{front} for a respective training epoch i=1, . . . , N_{epoch} and for a respective network layer j=1, . . . ,N_{layer} represents then the neural network M_{θ}_{ᵢ} for said training epoch i=1, . . . , N_{epoch} from the first network layer until and including the network layer at the clipping position N_{clipping}=[1, . . . , N_{layer} −1].

The back model M_{back} for a respective network layer j=1, . . . , N_{layer} represents the neural network

$${M}_{{θ}_{{N}_{epoch}}}$$

for the final training epoch from the network layer after the clipping position N_{clipping} =[1, . . . , N_{layer} −1] until the last network layer.

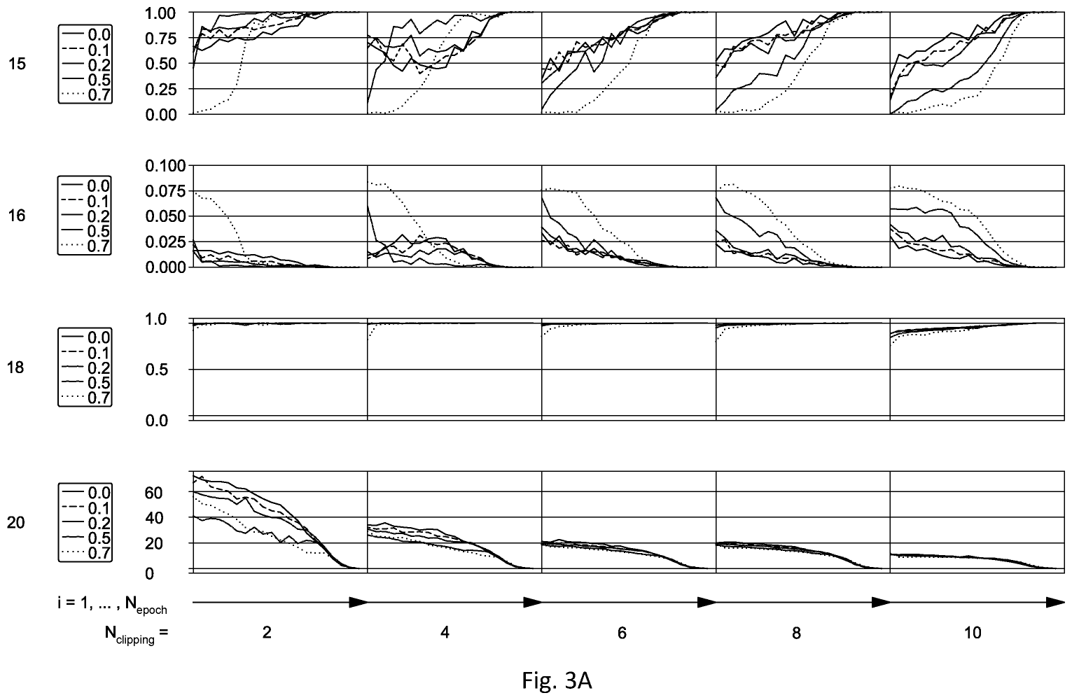

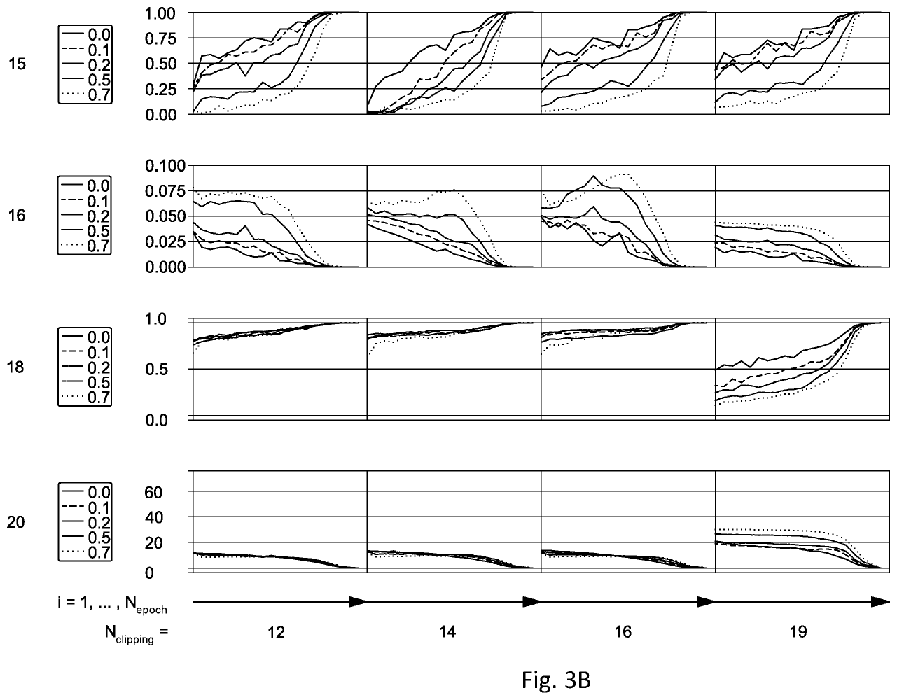

FIG. 3 shows a diagram of results of the method according to FIG. 2 for a plurality of joint neural networks for predicting a single task, each joint neural network having N_{layer}=19 network layers. In this case, the joint neural networks include each a VGG19 network with 16 convolution layers and three fully connected layers, respectively.

The joint neural networks have been each trained with a differently modified CIFAR100 training datasets [symbol] The CIFAR100 training dataset have been modified by adding different levels of noise thereto, which simulates different levels of a learning complexity of the task.

The first line of the diagram of FIG. 3 shows the prediction accuracy 15 for the plurality of joint neural networks with respect to the training epochs i=1, . . . , N_{epoch}, wherein the joint neural networks differ in the position of the joint, i.e., the clipping position N_{clipping}.

The second, third, and fourth line of the diagram of FIG. 3 respectively relate to a distance metric value with respect to the training epochs i=1, . . . ,N_{epoch}. The distance metric value is calculated by evaluating, respectively, a Kullback-Leibler (KL) divergence metric 16, a CKA distance metric 18 (see, e.g., Stephen Boyd and Lieven Vandenberghe; Convex optimization; Cambridge university press, 2004), and an L2 distance metric 20 on the model parameter θᵢ for the respective training epoch and the model parameter θ_{N}_{_{epoch}} of the final training epoch.

As can be derived from FIG. 3, the distance metric values show a behavior with respect to the different levels of the learning complexity of the task and with respective to the training epochs i=1, . . . ,N_{epoch} that is similar to the prediction accuracy 15. This finding motivates the use of a distance metric function d for aligning the training speed of different tasks in a multi-task neural network.

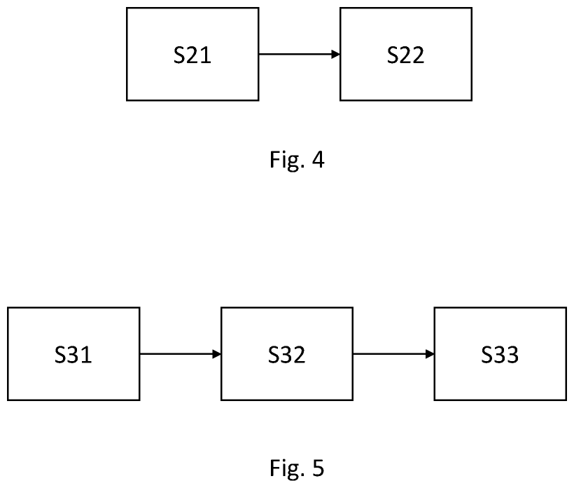

FIG. 4 shows a first embodiment of a computer-implemented method for training a multi-task neural network for predicting a plurality of T tasks, T≥2, simultaneously based on input data. An example of a pseudo-code B of the method according to FIG. 4 may read as follows:

```
Require: training dataset [symbol] , validation dataset [symbol] ′,
initialized parameter θ₀, training stage distance metric d,
parameterized optimization process Optim with its parameter ϕ
for i = 1,2, . . . , N_{epoch} do
  for x, y₀, . . . , y_{T}~ [symbol]   do
    for j = 1,2, . . . , T do
      θ′ⱼ1 ← θᵢ₋₁
        for k = i, . . . , N_{epoch} do
          for x, yⱼ~ [symbol]   do
            θ′ⱼ ← Optim_{ϕ} (θ′ⱼ, x, yⱼ)
        end for
      end for
    end for [symbol]
    ← Σₜ₌₁^{T} Σₜ₌₂^{T} ||d(θᵢ₋₁, θ′ₜ_{₁}) − d(θᵢ₋₁, θ′ₜ_{₂})||
    $ℒ ← \frac{1}{T} {\sum }_{t = 1}^{T} {\sum }_{{x}^{′} , {y}_{t}^{′} ∼ {𝒟}^{′}} \frac{1}{\vert {𝒟}^{′} \vert} {L}_{t} ( {θ}_{t}^{′} , {x}^{′} , {y}_{t}^{′} )$
    ϕ ← ϕ − α∇_{ϕ} ( [symbol]  + [symbol] )
    θᵢ ← Optim_{ϕ} (θᵢ₋₁, x, y₀, . . . , y_{T})
  end for
end for
```

In a step S21, the first embodiment includes:
Providing a multi-task neural network, a training dataset [symbol] for training the neural network on the plurality of T tasks, and a validation dataset [symbol] ′ for validating the neural network on the plurality of T tasks.

The training dataset D and the validation dataset [symbol] ′ represent jointly labelled datasets, where each data (e.g., picture) has multiple labels y₀, . . . ,y_{T}corresponding to the labels of all T tasks. The multiple labels y₀, . . . ,y_{T} may be used for training different tasks (e.g., object detection, semantic segmentation, depth estimation, etc.).

In a step S22, the first embodiment includes:
Training the multi-task neural network for the plurality of T tasks by using the training dataset [symbol] and the validation dataset [symbol] ′ such that a combined loss function is minimized within a predefined number N_{epoch} of training epochs.

The combined loss function for a respective training epoch depends on a sum of a plurality of single-task loss values for the respective training epoch and respectively from a single-task loss function Lₜ for a corresponding task t=1, . . . , T.

The respective single-task loss function Lₜ for the corresponding task t=1, . . . , T is validated on a corresponding single-task control parameter θₜ′ predicted in said training epoch and inputs of the validation dataset [symbol] ′ related to said task. The corresponding single-task control parameter θₜ′ is predicted in the respective training epoch by an optimization neural network Optim_{ϕ} that is meta-trained in said training epoch in relation to the corresponding task t₁, t₂=1, . . . , T.

The optimization neural network Optim_{ϕ} may be meta-trained for one or more meta-training steps in the respective training epoch. The number of meta-training steps in the respective training epoch may be variable and/or depending on the number of training epochs that are remaining from said training epoch until the N_{epoch}-th training epoch is reached. In other words, the optimization neural network Optim_{ϕ} may be meta-trained for predicting the single-task control parameter θₜ′ for the final training epoch.

The combined loss function for the respective training epoch further depends on a regularization value for the respective training epoch and from a regularization function for all pairs of tasks t₁, t₂=1, . . . , T.

The regularization function for a respective pair of tasks t₁, t₂=1, . . . , T is based on a difference between a corresponding pair of distance metric values respectively from a distance metric function d.

Each respective distance metric value for the respective training epoch is calculated in said training epoch by evaluating the distance metric function d on the corresponding single-task control parameter θₜ′ predicted in said training epoch.

The combined loss function and/or the single-task loss functions Lₜ may be based on one, several, or all of the following: a focal loss, a cross-entropy loss, and a bounding box regression loss.

The distance metric function d may be based on one, several, or all of the following: the Kullback-Leibler (KL) divergence metric 16, the CKA distance metric 18, and the L2 distance metric 20.

The regularization function may be based on a norm function of the difference, the norm function being preferably an absolute value function.

Reference is now made to the pseudo-code B:
In this case, the optimization neural network Optim_{ϕ} includes the multi-task neural network that is trained across the predefined number N_{epoch} of training epochs such that the combined loss function is minimized within the predefined number N_{epoch} of training epochs.

In other words, the optimization neural network Optim_{ϕ} is parameterized with an optimization parameter ϕ. The optimization parameter ϕ is adapted or updated in the respective training epoch based on the optimization parameter ϕ of the corresponding previous training epoch and a gradient descent of the combined loss function.

Furthermore, the optimization neural network Optim_{ϕ} is meta-trained in the respective training epoch for predicting the corresponding single-task control parameter θₜ′ in said training epoch based on inputs of the training dataset [symbol] related to said task t=1, . . . , T inputted to the optimization neural network Optim_{ϕ}.

Furthermore, the optimization neural network Optim_{ϕ} is trained for generating a multiple-task control parameter θᵢ, i=1, . . . , N_{epoch}, for the respective training epoch based on the multiple-task control parameter θᵢ₋₁ for the corresponding previous training epoch and/or inputs of the training dataset [symbol] related to each of the plurality of T tasks inputted to the optimization neural network Optim_{ϕ}.

Furthermore, the optimization neural network Optim_{ϕ} is meta-trained in the respective training epoch for predicting the corresponding single-task control parameter θₜ′ in said training epoch based on the multiple-task control parameter θᵢ₋₁ of the corresponding previous training epoch inputted to the optimization neural network Optim_{ϕ}.

Furthermore, the respective distance metric value for the respective training epoch is calculated in said training epoch by evaluating the distance metric function d on the multiple-task control parameter θᵢ for said training epoch.

Furthermore, the regularization function is based on the absolute value function.

FIG. 5 shows a second embodiment of the computer-implemented method for training the multi-task neural network. The second embodiment includes the steps of the first embodiment according to FIG. 4 (which are not shown).

In a step S31, the second embodiment includes:
Storing the trained multi-task neural network for predicting the plurality of T tasks simultaneously in a controlling device for generating a control signal for controlling an apparatus.

In a step S32, the second embodiment includes:
Inputting input data related to the apparatus to the trained multi-task neural network.

In a step S33, the second embodiment includes:
Generating, by the controlling device, the control signal for controlling the apparatus based on an output of the trained multi-task neural network.

Preferred embodiments of the invention may be summarized as follows:
Preferably, we first consider how to define and describe the training stage in a single task training process. Here we may use a backward perspective to define the training stage, i.e., we want to know whether a certain model in the training process is close enough to the final training model that we think is good enough. To describe the training stage more detailed, we preferably consider the features generated by each layer of the model. Recall that deep neural networks may show obvious hierarchical characteristics, which enables us to divide neural networks into two models according to any layer. This hierarchical approach to feature processing may still exist even when skip connections are considered.

Preferably, we use the term front-model to refer to the first half of the model separated from a layer, and back-model to refer to the second half. The front-model may be a mapping function from the input space to the hidden space, and the back-model may be a function from the hidden space into the label space. An idea is that if a front-model has acquired an enough strong feature extraction ability, there may be a very little performance gap compared with the final trained model when both using the back-model from the final model. It should be emphasized that this concept may primarily apply to the backward perspective, where the ultimate model is the outcome of training derived from the evaluated model. In instances where other parameter initializations or alternative training algorithms are employed, the final back-model may require an equivalent representation of the feature and cause a significant performance drop.

We provide our algorithm in pseudo-code A and results are shown in FIG. 3 on noisy CIFAR100 datasets.

Preferably, the noisy CIFAR100 datasets are constructed from the original CIFAR100 datasets, but we preferably replace some correct labels from training data to complete random noise. FIG. 3 shows the corresponding back-model's accuracy and the KL divergence, CKA distance, and L2 distance between features of the training models and the final model for each layer. The x-axis consists of multiple whole training processes for each VGG19 block.

As shown in FIG. 3, we compared our method with several commonly used feature similarity calculation methods, like L2 distance between features and CKA. Compared with other methods, our method presents more information and verifies the conclusions of many previous papers. For example, shallow neural networks are more inclined to learn simple features, shallow neural networks have a faster learning speed than deep ones, and neural networks tend to learn simple features that are easier to generalize at the beginning of the learning process and begin to memorize the noise in the data set at the later stage. We think, this method can show the training stage in more aspects and provide more information so that we hope to build on this method for designing a multi-task learning algorithm which tries to align training stage between different tasks.

In the case of multi-tasking, it may be hard to directly transfer the back-model from the single-task training to compare the training stages of all tasks, because the output of the back-model may be fundamentally different in different tasks. From the perspective of the data, the output may be in a different label space. From the perspective of the model, they may use separate task headers. Here, we suggest to use preferably the distance between features generated by the shared backbone. The back-model is regarded as the second half-part of the shared backbone, not including the task specific head. And extra training on each task may be needed, which starts from the evaluated multitask model in every training step until getting enough good single task models which are used as back-models. Then we can follow the above process to obtain the descriptions of all tasks for a multitask learning model.

Preferred embodiments of the invention provide a meta-learning approach to keep an aligned training stage during multitask training process. We first preferably use the difference between tasks' training stages to design a penalty term, e.g., the absolute value of the difference in distances for all layers and all tasks. However, since the calculation of the training stage may depend on the training algorithm, and our goal is to find a better multitask training algorithm, this may be a cyclic dependence problem.

We preferably use a meta-learning perspective, that is, we preferably use a meta-learning process to learn a neural network optimization process so that the training stage is aligned throughout the process. We preferably model this optimization process as a deep neural network as Optim_{ϕ}, and then we may train this optimization process with two major objectives: 1) this optimization process may minimize the original loss value for all tasks in a standard training time. 2) the penalty term is small. According to these two requirements, we provide our meta-learning algorithm in pseudo-code B.

In the actual implementation, we preferably use the neural network as a loss function and combine with standard gradient descent algorithm to form the whole optimization process, i.e., Optim_{ϕ} (θ, x,y)=θ−α∇L_{ϕ}(ƒ(θ(x),y). And we preferably do not actually train the single task network until optimal (getting the best θⱼ′), but instead use the model after multi-step stochastic gradient descent to greatly reduce computation.

The invention also provides a computing and/or controlling device comprising means adapted to execute the steps of the described method for training a multi-task neural network for predicting a plurality of T tasks, T≥2, simultaneously based on input data. The invention further provides a computer program comprising instructions to cause the computing and/or controlling device to execute the steps of the described method. The invention further provides a computer-readable storage medium having stored thereon the computer program.

### REFERENCE SIGNS

10 first task
12 second task
14a first case
14b second case
14c third case
14d fourth case
15 prediction accuracy
16 Kullback-Leibler (KL) divergence metric
18 CKA distance metric
20 L2 distance metric
d distance metric function
[symbol] training dataset
[symbol] ′ validation dataset
L loss function
Lₜ single-task loss function
M_{θ} single-task neural network
M_{front} front model
M_{back} back model
N_{clipping} clipping position
N_{epoch} number of training epochs
N_{layer} number of network layers
Optim_{ϕ}, optimization neural network
T number of tasks
θ model parameter
θᵢ model parameter/multiple-task control parameter of i-th training epoch
θₜ′ single-task control parameter of t-th task
ϕ optimization parameter

1. A computer-implemented method for training a multi-task neural network for predicting a plurality of T tasks, T≥2, simultaneously based on input data, the method comprising:
a) providing a multi-task neural network, a training dataset [symbol] for training the neural network on the plurality of T tasks, and a validation dataset [symbol] for validating the neural network on the plurality of T tasks; and
b) training the multi-task neural network for the plurality of T tasks across a predefined number N_{epoch} of training epochs by using the training dataset [symbol] and the validation dataset [symbol] ′ such that a combined loss function is minimized within the predefined number N_{epoch} of training epochs, wherein the combined loss function for a respective training epoch depends on:
a sum of a plurality of single-task loss values for the respective training epoch and respectively from a single-task loss function Lₜ for a corresponding task t=1, . . . , T, and
a regularization value for the respective training epoch and from a regularization function for all pairs of tasks t₁, t₂=1, . . . , T, the regularization function for a respective pair of tasks t₁, t₂=1, . . . , T being based on a difference between a corresponding pair of distance metric values respectively from a distance metric function d, each respective distance metric value for the corresponding task t=1, . . . , T being calculated in the respective training epoch by evaluating the distance metric function d on a corresponding single-task control parameter θₜ′ predicted in said training epoch, the corresponding single-task control parameter θₜ′ being predicted in said training epoch by an optimization neural network Optim_{ϕ} that is meta-trained in said training epoch in relation to said task.

2. The method according to claim 1, characterized in that the respective single-task loss function Lₜ for the corresponding task t=1, . . . , T is validated in the respective training epoch on the corresponding single-task control parameter θₜ′predicted in said training epoch and on inputs of the validation dataset [symbol] ′ related to said task.

3. The method according to claim 1,
characterized in that:
c1) the optimization neural network Optim_{ϕ} includes the multi-task neural network that is trained across the predefined number N_{epoch} of training epochs such that the combined loss function is minimized within the predefined number N_{epoch} of training epochs, and/or
c2) the optimization neural network Optim_{ϕ} is parameterized with an optimization parameter ϕ that is adapted in the respective training epoch based on the optimization parameter ϕ of the corresponding previous training epoch and a gradient descent of the combined loss function.

4. The method according to claim 1,
characterized in that the optimization neural network Optim_{ϕ} is meta-trained in the respective training epoch for predicting the corresponding single-task control parameter θₜ′ in said training epoch based on inputs of the training dataset [symbol] related to said task t=1, . . . , T inputted to the optimization neural network Optim_{ϕ}.

5. The method according to claim 1, characterized in that the optimization neural network Optim_{ϕ} is trained for generating a multiple-task control parameter θᵢ for the respective training epoch based on the multiple-task control parameter θᵢ₋₁ for the corresponding previous training epoch and/or inputs of the training dataset D related to each of the plurality of T tasks inputted to the optimization neural network Optim_{ϕ}.

6. The method according to claim 5, characterized in that the optimization neural network Optim_{ϕ} is meta-trained in the respective training epoch for predicting the corresponding single-task control parameter θₜ′ in said training epoch based on the multiple-task control parameter θᵢ₋₁ of the corresponding previous training epoch inputted to the optimization neural network Optim_{ϕ}.

7. The method according to claim 6, characterized in that the respective distance metric value for the respective training epoch is calculated in said training epoch by evaluating the distance metric function d on the multiple-task control parameter θᵢ for said training epoch.

8. The method according to claim 1, characterized in that the optimization neural network Optim_{ϕ} is meta-trained for one or more meta-training steps in the respective training epoch and/or the optimization neural network Optim_{ϕ} is meta-trained in said training epoch for predicting the single-task control parameter θₜ′ for the final training epoch.

9. The method according to claim 1, characterized in that the combined loss function and/or the single-task loss functions Lₜare based on one, several, or all of the following: a focal loss, a cross-entropy loss, and a bounding box regression loss.

10. The method according to claim 1, characterized in that the distance metric function is based on one, several, or all of the following: a Kullback-Leibler (KL) divergence metric, a CKA distance metric, and an L2 distance metric.

11. The method according to claim 1, characterized in that the regularization function is based on a norm function of the difference, the norm function being preferably an absolute value function.

12. The method according to claim 1, further comprising:
d1) Storing the trained multi-task neural network for predicting the plurality of T tasks simultaneously in a controlling device for generating a control signal for controlling an apparatus;
d2) Inputting input data related to the apparatus to the trained multi-task neural network; and
d3) Generating, by the controlling device, the control signal for controlling the apparatus based on an output of the trained multi-task neural network.

13. A computing and/or controlling device comprising means adapted to execute the steps of the method according to claim 1.

14. A computer program comprising instructions to cause a computing and/or controlling device to execute the steps of the method according to claim 1.

15. A computer-readable storage medium having stored thereon the computer program of claim 14.
